(19) United States
(12) Patent Application Publication
(10) Pub. No.: US 2026/0364709 A1
(43) Pub. Date: Nov. 19, 2026

(54) ULTRASONIC WELDING SYSTEMS, SONOTRODES FOR ULTRASONIC WELDING SYSTEMS, AND RELATED METHODS

(71) Applicant: Kulicke and Soffa Industries, Inc., Fort Washington, PA (US)

(72) Inventor: Henri Seppaenen, Irvine, CA (US)

(73) Assignee: Kulicke and Soffa Industries, Inc., Fort Washington, PA (US)

(21) Appl. No.: 19/667,870

(22) Filed: May 5, 2026

Related U.S. Application Data
(60) Provisional application No. 63/807,255, filed on May 16, 2025.

(51) Int. Cl. B23K 20/10; B23K 101/38

(52) U.S. Cl. CPC B23K 20/106; B23K 2101/38

(57) ABSTRACT

A sonotrode configured for use in an ultrasonic welding system is provided. The sonotrode includes a body portion terminating at a tip portion. The tip portion includes a working surface, the working surface defining an aperture configured to engage a conductive pin during an ultrasonic welding process. The tip portion further defines a notch away from the aperture, the notch providing clearance from adjacent structures during the ultrasonic welding process.

### CROSS-REFERENCE TO RELATED APPLICATION

This application claims the benefit of U.S. Provisional Application No. 63/807,255, filed on May 16, 2025, the content of which is incorporated herein by reference.

### FIELD

The invention relates to the ultrasonic welding, and more particularly, to improved sonotrodes for use in ultrasonic welding systems, such as ultrasonic welding systems for conductive pin welding.

### Background

Ultrasonic energy is widely used in forming interconnections between two or more materials. For example, wire bonding machines (e.g., ball bonding machines, wedge bonding machines, ribbon bonding machines, etc.) are used to bond a wire or ribbon to a bonding location. Wire bonding utilizes relatively low levels of energy (e.g., bond force, ultrasonic energy, etc.). Exemplary wire bonding machines are marketed by Kulicke and Soffa Industries, Inc. of Fort Washington, Pennsylvania.

Certain applications involve joining of materials other than wire. Welding has been considered for such applications. Ultrasonic welding is also a widely used technology. Ultrasonic welding may use an ultrasonic converter (e.g., carrying a sonotrode) for converting electrical energy into mechanical movement/scrub (e.g., linear movement/scrub, torsional movement/scrub, etc.). However, existing ultrasonic welding technology and equipment is limited in its ability to provide solutions that can satisfy market demand in terms of cost, operational efficiency, flexibility, portability, and related factors.

U.S. Patent No. 10,882,134 (entitled “Ultrasonic Welding Systems and Methods of Using the Same”), U.S. Patent No. 11,364,565 (entitled “Ultrasonic Welding Systems and Methods of Using the Same”), U.S. Patent No. 11,850,676 (entitled “Ultrasonic Welding Systems, Methods of Using the Same, and Related Workpieces Including Welded Conductive Pins”), U.S. Patent No. 12,070,814 (entitled “Ultrasonic Welding Systems, Methods of Using the Same, and Related Workpieces Including Welded Conductive Pins”), U.S. Patent No. 12,377,489 (entitled “Ultrasonic Welding Systems, Methods of Using the Same, and Related Workpieces Including Welded Conductive Pins”), U.S. Patent No. 12,370,620 (entitled “Ultrasonic Welding Systems for Conductive Pins, and Related Methods”), and International Patent Publication No. WO2024/0220203 (entitled “Ultrasonic Welding Systems, Sonotrodes and Conductive Pins for Such Systems, and Related Methods and Workpieces”), U.S. Patent Application Publication No. 2025/0187103 (entitled “CONDUCTIVE PINS, POWER MODULES, ULTRASONIC WELDING SYSTEMS, AND METHODS OF USING THE SAME”), U.S. Patent Application Publication No. 2025/0289074 (entitled “ULTRASONIC WELDING SYSTEMS, AND SONOTRODES FOR ULTRASONIC WELDING SYSTEMS”), and U.S. Patent Application Publication No. 2026/0014641 (entitled “SONOTRODES FOR ULTRASONIC WELDING SYSTEMS, ULTRASONIC WELDING SYSTEMS, AND RELATED METHODS”), each of which being assigned to Kulicke and Soffa Industries, Inc., relate to improvements in ultrasonic welding technology, and are incorporated herein by reference in their entirety.

Still, improvements are needed in connection with specific applications of ultrasonic welding, including ultrasonic pin welding. For example, in ultrasonic pin welding, conductive pins configured to be welded in a fine pitch arrangement on a workpiece may be difficult to weld without interfering with adjacent structures (e.g., adjacent conductive pins). Thus, it would be desirable to provide improved sonotrodes, and ultrasonic welding systems including such sonotrodes, configured for use in connection with ultrasonic pin welding.

### SUMMARY

According to an exemplary embodiment of the invention, a sonotrode configured for use in an ultrasonic welding system is provided. The sonotrode includes a body portion terminating at a tip portion. The tip portion includes a working surface. The working surface defines an aperture configured to engage a conductive pin during an ultrasonic welding process. The tip portion further defines a plurality of recesses away from the aperture. The plurality of recesses provide clearance from adjacent structures (e.g., wherein such adjacent structures could include one or more adjacent structures, wherein adjacent structures may include a body portion of adjacent conductive pins, etc.) during the ultrasonic welding process.

According to another exemplary embodiment of the invention, an ultrasonic welding system is provided. The ultrasonic welding system includes a support structure configured for supporting a workpiece. The ultrasonic welding system also includes a weld head assembly including an ultrasonic converter and a sonotrode configured for use in the ultrasonic welding system. The sonotrode includes a body portion terminating at a tip portion. The tip portion includes a working surface. The working surface defines an aperture configured to engage a conductive pin during an ultrasonic welding process. The tip portion further defines a plurality of recesses away from the aperture. The plurality of recesses provide clearance from adjacent structures during the ultrasonic welding process.

According to other embodiments of the invention, the sonotrode recited in either of the two immediately preceding paragraphs may have any one or more of the following features: the plurality of recesses are arranged around the aperture as seen from an end view of the sonotrode; the plurality of recesses are arranged radially around the aperture as seen from an end view of the sonotrode; the plurality of recesses are arranged symmetrically with respect to the aperture; the plurality of recesses are arranged in a pattern, the pattern being configured to match a corresponding arrangement of conductive pins adjacent the conductive pin on a workpiece during the ultrasonic welding process; the plurality of recesses are arranged in a linear configuration with respect to the aperture; the body portion includes a cylindrical portion extending to a conical portion, the conical portion including the working surface, the plurality of recesses being defined at an intersection between the cylindrical portion and the conical portion; the intersection includes a curved portion between the cylindrical portion and the conical portion; adjacent structures include previously bonded conductive pins; ones of the plurality of recesses are configured to receive ones of the previously bonded conductive pin during the ultrasonic welding process; and/or the tip portion further defines a notch away from the aperture, the notch providing clearance from adjacent structures (e.g., wherein adjacent structures may be the same or different adjacent structures) during the ultrasonic welding process.

According to another exemplary embodiment of the invention, a sonotrode configured for use in an ultrasonic welding system is provided. The sonotrode includes a body portion terminating at a tip portion. The tip portion includes a working surface. The working surface defines an aperture configured to engage a conductive pin during an ultrasonic welding process. The tip portion further defines a notch away from the aperture. The notch provides clearance from adjacent structures (e.g., wherein such adjacent structures could include one or more adjacent structures, wherein adjacent structures may include a base portion of adjacent conductive pins, etc.) during the ultrasonic welding process.

According to another exemplary embodiment of the invention, an ultrasonic welding system is provided. The ultrasonic welding system includes a support structure configured for supporting a workpiece. The ultrasonic welding system also includes a weld head assembly including an ultrasonic converter and a sonotrode configured for use in the ultrasonic welding system. The sonotrode includes a body portion terminating at a tip portion. The tip portion includes a working surface. The working surface defines an aperture configured to engage a conductive pin during an ultrasonic welding process. The tip portion further defines a notch away from the aperture. The notch provides clearance from adjacent structures (e.g., base portions of adjacent conductive pins) during the ultrasonic welding process.

According to other embodiments of the invention, the sonotrode recited in either of the two immediately preceding paragraphs may have any one or more of the following features: the notch is defined at an edge of the working surface; the notch is a rectangular notch; the notch is a tapered notch; the notch is a rounded notch; the notch is defined at an intersection of the working surface and a side surface of the tip portion; the notch is an annular notch surrounding the aperture; and/or the tip portion defines a plurality of recesses away from the aperture, the plurality of recesses providing clearance from adjacent structures (e.g., wherein adjacent structures may be the same or different adjacent structures) during the ultrasonic welding process.

According to another exemplary embodiment of the invention, a method of preparing a sonotrode for use in connection with an ultrasonic welding process is provided. The method includes the steps of: (a) providing a body portion of the sonotrode terminating at a tip portion, the tip portion including a working surface, the working surface defining an aperture configured to engage a conductive pin during the ultrasonic welding process; and (b) defining a plurality of recesses in the tip portion away from the aperture, the plurality of recesses providing clearance from adjacent structures during the ultrasonic welding process.

According to other embodiments of the invention, the method recited in the immediately preceding paragraph may have any one or more of the following features: step (b) includes arranging the plurality of recesses around the aperture as seen from an end view of the sonotrode; step (b) includes arranging the plurality of recesses radially around the aperture as seen from an end view of the sonotrode; step (b) includes arranging the plurality of recesses symmetrically with respect to the aperture; step (b) includes arranging the plurality of recesses in a pattern, the pattern being configured to match a corresponding arrangement of conductive pins adjacent the conductive pin on a workpiece during the ultrasonic welding process; step (b) includes arranging the plurality of recesses in a linear configuration with respect to the aperture; the body portion includes a cylindrical portion extending to a conical portion, the conical portion including the working surface, and step (b) includes defining the plurality of recesses at an intersection between the cylindrical portion and the conical portion; the intersection includes a curved portion between the cylindrical portion and the conical portion; step (b) includes defining ones of the plurality of recesses to receive ones of previously bonded conductive pins during the ultrasonic welding process; and/or defining a notch in the tip portion away from the aperture, the notch providing clearance from adjacent structures during the ultrasonic welding process.

According to another exemplary embodiment of the invention, a method of preparing a sonotrode for use in connection with an ultrasonic welding process is provided. The method includes the steps of: (a) providing a body portion of the sonotrode terminating at a tip portion, the tip portion including a working surface, the working surface defining an aperture configured to engage a conductive pin during the ultrasonic welding process; and (b) defining a notch in the tip portion away from the aperture, the notch providing clearance from adjacent structures during the ultrasonic welding process.

According to other embodiments of the invention, the method recited in the immediately preceding paragraph may have any one or more of the following features: step (b) includes defining the notch at an edge of the working surface; step (b) includes defining the notch as a rectangular notch; step (b) includes defining the notch as a tapered notch; step (b) includes defining the notch as a rounded notch; step (b) includes defining the notch at an intersection of the working surface and a side surface of the tip portion; step (b) includes defining the notch as an annular notch surrounding the aperture; and/or defining a plurality of recesses in the tip portion away from the aperture, the plurality of recesses providing clearance from adjacent structures during the ultrasonic welding process.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1A is a cross-sectional block diagram side view of a sonotrode in accordance with an exemplary embodiment of the invention;

FIG. 1B is an end view of the sonotrode of FIG. 1A;

FIG. 1C is a top view of a plurality of conductive pins used in connection with the sonotrode of FIGS. 1A-1B;

FIG. 1D is a side view of the plurality of conductive pins of FIG. 1C;

FIG. 1E is a cross-sectional block diagram side view of the sonotrode of FIGS. 1A and 1B engaged with the plurality of conductive pins of FIGS. 1C and 1D, in accordance with an exemplary embodiment of the invention;

FIG. 1F is an end view of the sonotrode and the plurality of conductive pins illustrated in FIG. 1E;

FIG. 2A is a block diagram end view of a tip portion of a sonotrode in accordance with another exemplary embodiment of the invention;

FIG. 2B is a top view of a plurality of conductive pins arranged in a pattern to be used in connection with the sonotrode of FIG. 2A;

FIG. 3A is a block diagram end view of a tip portion of a sonotrode in accordance with yet another exemplary embodiment of the invention;

FIG. 3B is a top view of a plurality of conductive pins arranged in a pattern to be used in connection with the sonotrode of FIG. 3A;

FIG. 4A is a block diagram end view of a tip portion of a sonotrode in accordance with yet another exemplary embodiment of the invention;

FIG. 4B is a top view of a plurality of conductive pins arranged in a pattern to be used in connection with the sonotrode of FIG. 4A;

FIG. 5A is a block diagram end view of a tip portion of a sonotrode in accordance with yet another exemplary embodiment of the invention;

FIG. 5B is a top view of a plurality of conductive pins arranged in a pattern to be used in connection with the sonotrode of FIG. 5A;

FIG. 6A is a cross-sectional block diagram side view of a sonotrode being used in connection with a plurality of conductive pins, in accordance with an exemplary embodiment of the invention;

FIG. 6B is a detailed view of a portion of FIG. 6A;

FIG. 7A is a cross-sectional block diagram side view of a sonotrode being used in connection with a plurality of conductive pins, in accordance with an exemplary embodiment of the invention;

FIG. 7B is a detailed view of a portion of FIG. 7A;

FIG. 8A is a cross-sectional block diagram side view of a sonotrode being used in connection with a plurality of conductive pins, in accordance with an exemplary embodiment of the invention;

FIG. 8B is a detailed view of a portion of FIG. 8A;

FIG. 9 is a block diagram side view of an ultrasonic welding system including a sonotrode (e.g., being one or more of the sonotrodes illustrated in FIGS. 1A-1B,1E-1F,2A,3A,4A,5A,6A-6B,7A-7B; and/or 8A-8B, ) In accordance with various exemplary embodiments of the invention; and

FIGS. 10 and 11 are flow diagrams illustrating methods of preparing a sonotrode for use in connection with an ultrasonic welding process in connection with various embodiments of the invention.

### DETAILED DESCRIPTION

Sonotrodes used in connection with an ultrasonic welding system (e.g., configured to ultrasonically weld, such as through torsional motion or other motions, conductive pins to a workpiece) are described herein. Certain exemplary sonotrodes disclosed herein provide advantages in ultrasonic welding operations of conductive pins arranged in certain patterns (e.g., a fine pitch pattern, tightly packed conductive pins, etc.). Accordingly, certain exemplary embodiments of sonotrodes disclosed herein enable high pitch conductive pin welding.

Certain embodiments disclosed herein include a sonotrode with vertical recesses (e.g., apertures, holes, etc.) that enable high pitch welding of conductive pins. In certain embodiments, such a sonotrode defines vertical recesses (e.g., apertures, holes, etc.) at a conical portion of the sonotrode (and/or at a cylindrical section of the sonotrode). Vertical recesses may be symmetrically arranged (e.g., around a central aperture of the sonotrode) to avoid unwanted vibration modes (e.g., resonances). Vertical recesses may be defined at a specific distance from a central aperture (e.g., center welding hole) of the sonotrode. The vertical recess diameter may be configured such that an elongate portion (e.g., a body portion) of a conductive pin fits in one of the recesses without touching the sonotrode. Vertical recesses may enable long conductive pin welding at high pitch by enabling adjacent structures (e.g., neighboring conductive pins) to be inserted into the recesses while a center conductive pin (e.g., engaged with the central aperture) is welded. Certain embodiments disclosed herein may be used in a matrix pin welding system where conductive pins are placed in an organized matrix (e.g., having a high pitch pattern) with high pitch application.

As used herein, the term “conductive pin” is intended to refer to any conductive structure intended to be welded (e.g., ultrasonically welded) to a workpiece. The conductive pin may have a free end (after being welded to a workpiece), and a body portion of the conductive pin may extend substantially vertically from a “welded” end to the free end. The cross section of the conductive pin may be round, square, rectangular, or have any desired cross section. The term conductive pin shall also be construed to include conductive receptacles or sleeves (e.g., having a tubular shape such as a rivet), where the conductive receptacle/sleeve is ultrasonically welded to a workpiece, and configured to receive another conductive element.

As used herein, “annular” is intended to be interpreted broadly to mean a rounded shape (e.g., a circle, a ring, a ringlike shape, an anulus, an ellipse, an oval, etc.) surrounding a point (e.g., an aperture). It should be understood that any other polygonal and/or geometric shape surrounding a central point may, in certain embodiments, be referred to as “annular” within the scope of the invention.

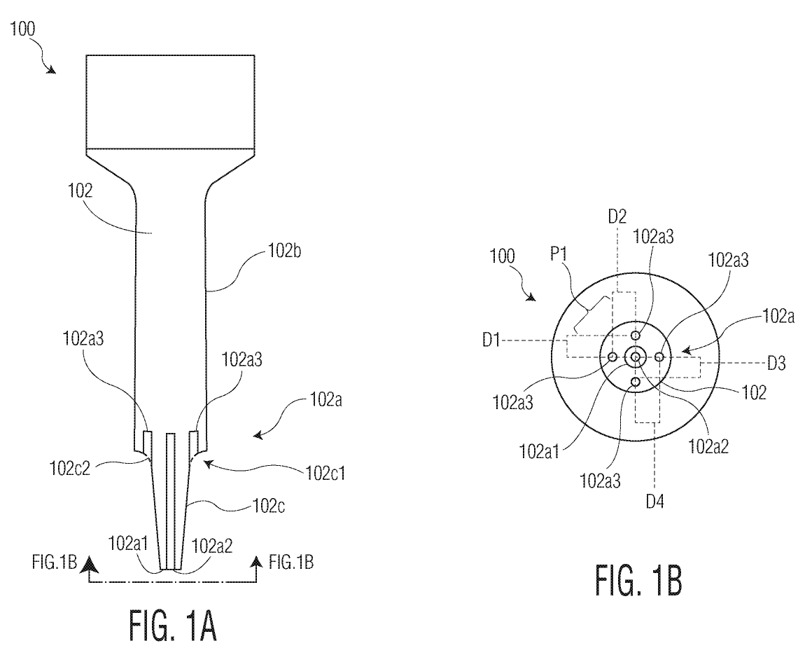

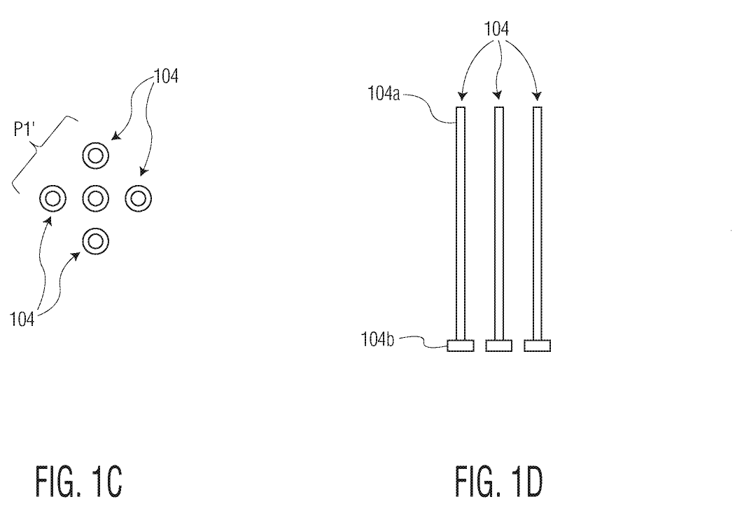

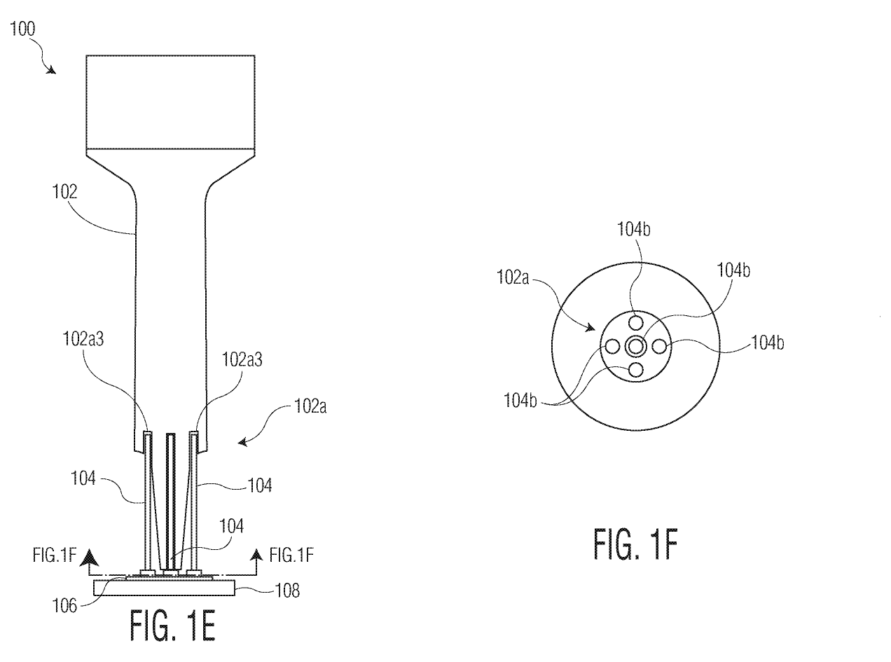

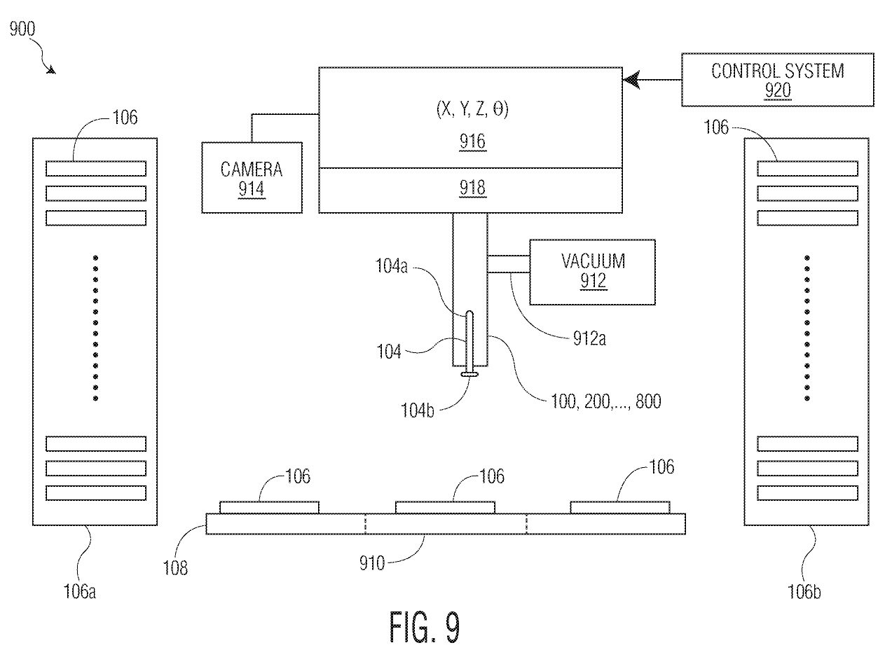

Referring now to the drawings, FIG. 1A illustrates a sonotrode 100 configured for use in an ultrasonic welding system (e.g., ultrasonic welding system 900 of FIG. 9). Sonotrode 100 may be used in connection with an ultrasonic welding operation, where a conductive pin (e.g., conductive pin 104 of FIGS. 1C-1D) is being welded to a workpiece (e.g., workpiece 106 of FIG. 1E) supported by a support structure (e.g., support structure 108 of ultrasonic welding system 900 of FIG. 9). Exemplary workpieces include a substrate, a semiconductor element, a power module, etc.

Sonotrode 100 includes a body portion 102 terminating at a tip portion 102a. Tip portion 102aincludes a working surface 102a1. Working surface 102a1 defines an aperture 102a2 configured to engage a conductive pin (e.g., conductive pin 104 of FIGS. 1C-1D) during an ultrasonic welding process. Tip portion 102afurther defines a plurality of recesses 102a3 away from (e.g., radially around) aperture 102a2. The plurality of recesses 102a3 (e.g., vertical holes) are configured to provide clearance from adjacent structures (e.g., conductive pins) during the ultrasonic welding process. In certain embodiments, the adjacent structures include at least one previously bonded conductive pin. In certain embodiments, ones of the plurality of recesses 102a3 are configured to receive ones of the at least one previously bonded conductive pin during the ultrasonic welding process.

Body portion 102 includes a cylindrical portion 102b extending to a conical portion 102c. Conical portion 102cincludes working surface 102a1. Each of the plurality of recesses 102a3 is defined at an intersection 102c1 between cylindrical portion 102b and conical portion 102c. In certain embodiments, intersection 102c1 includes a curved portion 102c2 between cylindrical portion 102b and conical portion 102c.

Working surface 102a1, aperture 102a2, and the plurality of recesses 102a3 are illustrated in greater detail in FIG. 1B. As can be seen from the end view of sonotrode 100, the plurality of recesses 102a3 are arranged around aperture 102a2 (e.g., separated by a distance D1, a distance D2, etc.). In the illustrated embodiment, the plurality of recesses 102a3 may be described as arranged radially around aperture 102a2 (e.g., as seen from the illustrated end view of sonotrode 100), where distance D1 is equal to distance D2, a distance D3, and a distance D4. In the illustrated embodiment, the plurality of recesses 102a3 may be described as arranged symmetrically with respect to aperture 102a2 – in this exemplary symmetrical arrangement, distance D1 equals distance D3 and distance D2 equals distance D4 (e.g., where there is more than one axis of symmetry with respect to aperture 102a2).

In certain embodiments, the plurality of recesses 102a3 may be arranged in a pattern, the pattern being configured to match a corresponding arrangement of conductive pins (e.g., conductive pins bonded to a workpiece that are adjacent to a conductive pin engaged with sonotrode 100, where the conductive pin engaged with sonotrode 100 is about to be ultrasonically welded to the workpiece). In FIG. 1B, the plurality of recesses 102a3 are arranged in a pattern P1 (e.g., a “cross”, a “t”, or a “+” pattern). Similarly, referring now to FIG. 1C, a plurality of conductive pins 104 are arranged in a corresponding pattern P1’ (e.g., a “cross”, a “t”, or a “+” pattern). Accordingly, the plurality of recesses 102a3 of sonotrode 100 are configured to interact with the previously welded conductive pins 104 (e.g., where the center of each of the plurality of recesses 102a3 is positioned such that each of the plurality of recesses 102a3 can accept a body portion of a corresponding conductive pin 104). Referring now to FIG. 1D, the plurality of conductive pins 104 are illustrated in further detail. Each of the plurality of conductive pins 104 includes a body portion 104a (e.g., an elongate portion configured to be provided to an aperture of a sonotrode, etc.) and an end portion 104b (e.g., a base portion, a portion configured to be ultrasonically welded to a workpiece, etc.).

Referring now to FIG. 1E, sonotrode 100 is illustrated engaged in a welding process (e.g., an ultrasonic welding process, an ultrasonic welding operation, etc.), where one of the plurality of conductive pins 104 is being welded to a workpiece 106 (e.g., a substrate, a semiconductor element, a power module, etc.) supported by a support structure 108 (e.g., of an ultrasonic welding system). Others of the plurality of conductive pins 104, which have been previously bonded to workpiece 106, are engaged with corresponding ones of the plurality of recesses 102a3 during the ultrasonic welding operation. A diameter of each of the plurality of recesses 102a3 may be selected to provide a desired tolerance (e.g., a tolerance allowing for easy engagement with the previously welded pins, a tolerance such that previously welded pins are not damaged during bonding of a current pin, a tolerance adequate to avoid contact between previously welded pins and sonotrode 100, etc.).

FIG. 1F illustrates each of the plurality of conductive pins 104 engaged with a corresponding one of the plurality of recesses 102a3 and/or aperture 102a2 (the plurality of recesses 102a3 and aperture 102a2 being obstructed from view in FIG. 1F by the end portions 104b of conductive pins 104).

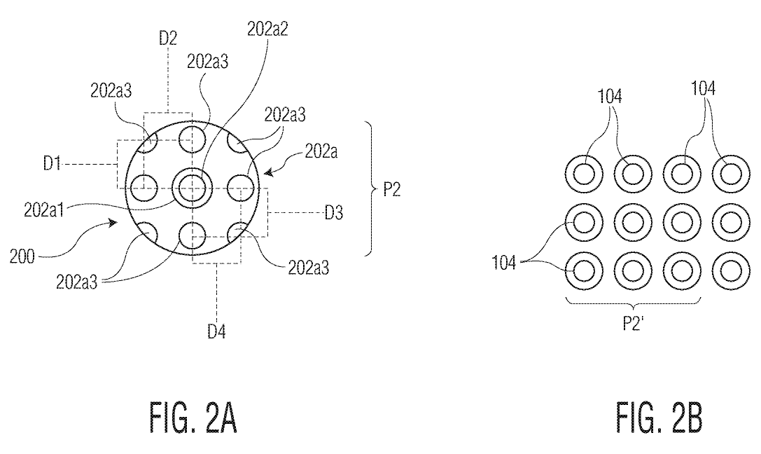

A number of different embodiments of tip portions of exemplary sonotrodes (and patterns of conductive pins to use therewith) are illustrated in further detail in FIGS. 2A-2B,3A-3B,4A-4B, and 5A-5B, . It should be understood that the details illustrated therein are applicable to exemplary sonotrode 100 used in connection with FIGS. 1A-1F, except tip portion 102a and conductive pins 104 are substituted with the corresponding features illustrated in FIGS. 2A-2B,3A-3B,4A-4B. and 5A-5B . Accordingly, like reference numerals denote like elements and similar reference numerals (beginning with a “2”, “3”, “4”, or “5” in lieu of a “1”) denote similar or analogous elements.

Referring specifically to FIG. 2A, a tip portion 202a of a sonotrode 200 is illustrated. Tip portion 202aincludes a working surface 202a1. Working surface 202a1 defines an aperture 202a2 configured to engage a conductive pin (e.g., conductive pin 104) during an ultrasonic welding process. Tip portion 202aincludes a plurality of recesses 202a3 providing clearance from adjacent structures (e.g., at least one conductive pin 104) during an ultrasonic welding process.

As can be seen (e.g., from the end view of an exemplary sonotrode) in FIG. 2A, the plurality of recesses 202a3 are arranged around aperture 202a2 (e.g., separated by distance D1, distance D2, distance D3, distance D4, and/or other distances for outer recesses 202a3, etc.). In the illustrated embodiment, the plurality of recesses 202a3 may be described as arranged symmetrically with respect to aperture 202a2, where distance D1 equals distance D3 and/or distance D2 equals distance D4.

In certain embodiments, the plurality of recesses 202a3 may be arranged in a pattern, the pattern being configured to match a corresponding arrangement of conductive pins (e.g., conductive pins bonded to a workpiece that are adjacent to a conductive pin engaged with sonotrode 200 and about to be ultrasonically welded to the workpiece). In the illustrated embodiment, the plurality of recesses 202a3 are arranged in a pattern P2 (e.g., a grid pattern, a plurality of linear arrangements, etc.). Similarly, referring now to FIG. 2B, a plurality of conductive pins 104 are arranged in a corresponding pattern P2’ (e.g., a grid pattern, a plurality of linear arrangements, etc.). Accordingly, the plurality of recesses 202a3 (of sonotrode 200) are configured to interact with the plurality of conductive pins 104 (e.g., where the center of each of the plurality of recesses 202a3 is positioned such that each of the plurality of recesses 202a3 can accept a body portion of a corresponding conductive pin 104).

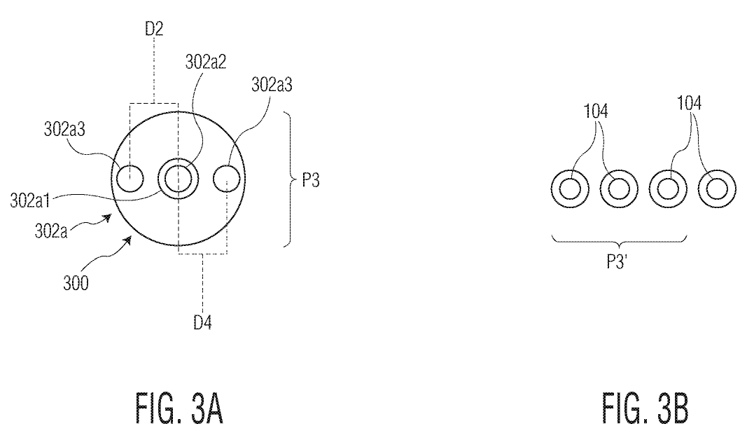

Referring now to FIG. 3A, a tip portion 302a of a sonotrode 300 is illustrated. Tip portion 302aincludes a working surface 302a1. Working surface 302a1 defines an aperture 302a2 configured to engage a conductive pin (e.g., conductive pin 104) during an ultrasonic welding process. Tip portion 302ais illustrated including a plurality of recesses 302a3 providing clearance from adjacent structures (e.g., at least one conductive pin 104) during an ultrasonic welding process.

As can be seen (e.g., from the end view of an exemplary sonotrode) in FIG. 3A, the plurality of recesses 302a3 are arranged away from aperture 302a2 (e.g., separated by distance D2, distance D4, etc.). In the illustrated embodiment, the plurality of recesses 302a3 may be described as arranged symmetrically with respect to aperture 302a2, where distance D2 equals distance D4. In the illustrated embodiment, the plurality of recesses 302a3 may be described as arranged in a linear configuration with respect to aperture 302a2 (e.g., where the one of the plurality of recesses 302a3, aperture 302a2, and another of the plurality of recesses 302a3 are arranged in a line with respect to one another).

In certain embodiments, the plurality of recesses 302a3 may be arranged in a pattern, the pattern being configured to match a corresponding arrangement of conductive pins (e.g., conductive pins bonded to a workpiece that are adjacent to a conductive pin engaged with sonotrode 300 and about to be ultrasonically welded to the workpiece). In the illustrated embodiment, the plurality of recesses 302a3 are arranged in a pattern P3 (e.g., a linear pattern, etc.). Similarly, referring now to FIG. 3B, a plurality of conductive pins 104 are arranged in a corresponding pattern P3’ (e.g., a linear pattern, etc.). Accordingly, the plurality of recesses 302a3 (of an exemplary sonotrode) are configured to interact with the plurality of conductive pins 104 (e.g., where the center of each of the plurality of recesses 302a3 is positioned such that each of the plurality of recesses 302a3 can accept a body portion of a corresponding conductive pin 104).

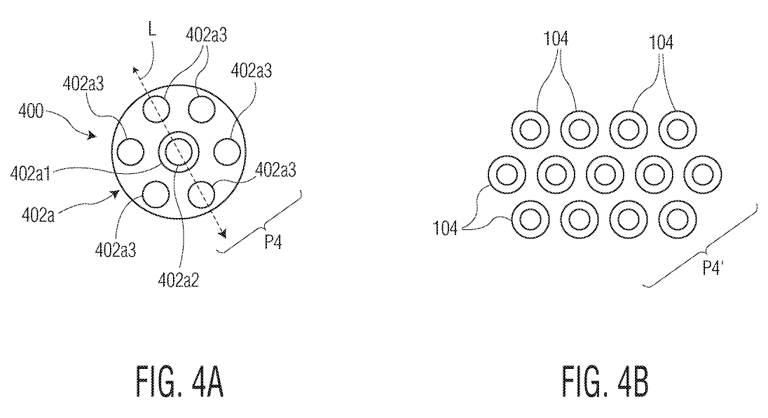

Referring now to FIG. 4A, a tip portion 402a of a sonotrode 400 is illustrated. Tip portion 402a includes a working surface 402a1. Working surface 402a1 defines an aperture 402a2 configured to engage a conductive pin (e.g., conductive pin 104) during an ultrasonic welding process. Tip portion 402ais illustrated including a plurality of recesses 402a3 providing clearance from adjacent structures (e.g., conductive pin 104) during an ultrasonic welding process.

As can be seen (e.g., from the end view of an exemplary sonotrode) in FIG. 4A, the plurality of recesses 402a3 are arranged around aperture 402a2. In the illustrated embodiment, the plurality of recesses 402a3 may be described as arranged symmetrically with respect to aperture 402a2 along various lines of symmetry (e.g., see exemplary line “L” shown in FIG. 4A).

In certain embodiments, the plurality of recesses 402a3 may be arranged in a pattern, the pattern being configured to match a corresponding arrangement of conductive pins (e.g., conductive pins bonded to a workpiece that are adjacent to a conductive pin engaged with sonotrode 400 and about to be ultrasonically welded to the workpiece). In the illustrated embodiment, the plurality of recesses 402a3 are arranged in a pattern P4 (e.g., a hexagonal pattern, an offset pattern of linear arrangements, etc.). Similarly, referring now to FIG. 4B, a plurality of conductive pins 104 are arranged in a corresponding pattern P4’ (e.g., a hexagonal pattern, an offset pattern of linear arrangements, etc.). Accordingly, the plurality of recesses 402a3 (of an exemplary sonotrode) are configured to interact with the plurality of conductive pins 104 (e.g., where the center of each of the plurality of recesses 402a3 is positioned such that each of the plurality of recesses 402a3 can accept a body portion of a corresponding conductive pin 104).

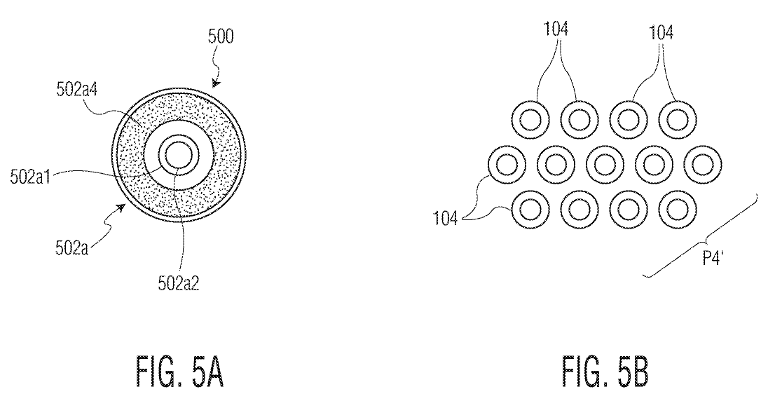

Referring now to FIG. 5A, a tip portion 502a of a sonotrode 500 is illustrated. Tip portion 502a includes a working surface 502a1. Working surface 502a1 defines an aperture 502a2 configured to engage a conductive pin (e.g., conductive pin 104) during an ultrasonic welding process. Tip portion 502afurther defines a notch 502a4 away from the aperture. Notch 502a4 provides clearance from adjacent structures (e.g., conductive pin 104) during an ultrasonic welding process.

As can be seen (e.g., from the end view of an exemplary sonotrode) in FIG. 5A, notch 502a4 is arranged around aperture 502a2. In the illustrated embodiment, notch 502a4 may be described as an annular notch surrounding aperture 502a2.

In certain embodiments, notch 502a4 may be configured to match a corresponding arrangement of conductive pins (configured to be bonded to during an ultrasonic welding process). Referring now to FIG. 5B, a plurality of conductive pins 104 are arranged in a pattern P4’ (e.g., a hexagonal pattern, an offset pattern of linear arrangements, etc.). Notch 502a4 is configured to interact with the plurality of conductive pins 104 (e.g., such that notch 502a4 may accept a body portion of a plurality of conductive pins 104). Notch 502a4 may be used in lieu of a plurality of recesses (e.g., plurality of recesses 402a3) and work with the same pattern P4’ of the plurality of conductive pins 104 illustrated in FIG. 4B, depending on the application and pattern.

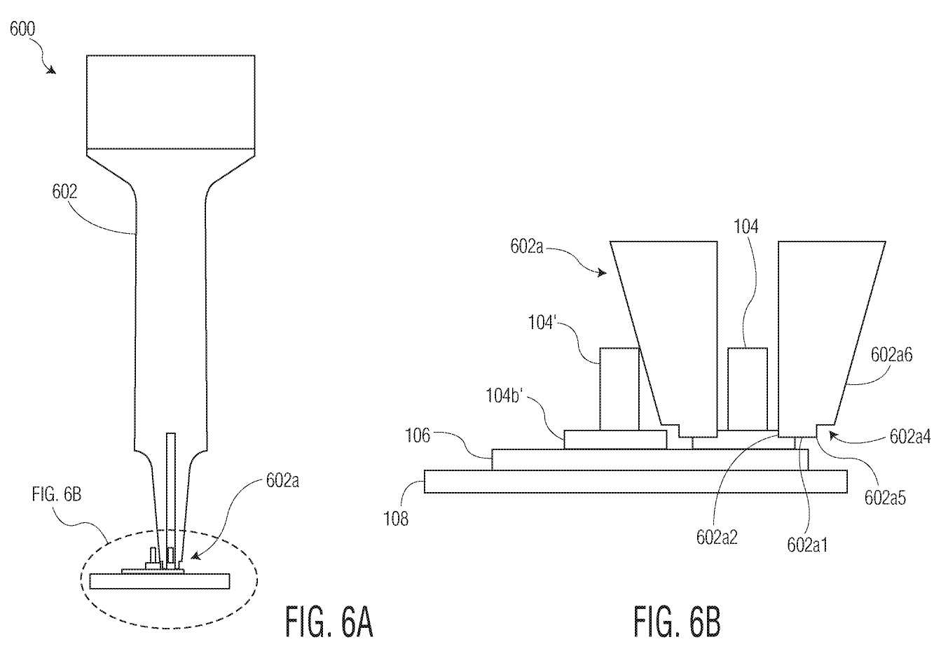

It should be understood that a number of different notches may be used in accordance with various exemplary embodiments of the invention. Referring now to FIGS. 6A-6B, a sonotrode 600 configured for use in an ultrasonic welding system (e.g., ultrasonic welding system 900 of FIG. 9) is illustrated. Sonotrode 600 may be used in connection with an ultrasonic welding operation, where a conductive pin (e.g., conductive pin 104) is being welded to workpiece 106 (e.g., a substrate, a semiconductor element, a power module, etc.) supported by support structure 108 (e.g., of an ultrasonic welding system).

Sonotrode 600 is illustrated including a body portion 602 terminating at a tip portion 602a. Tip portion 602aincludes a working surface 602a1. Working surface 602a1 defines an aperture 602a2 configured to engage a conductive pin 104 during an ultrasonic welding process. Tip portion 602afurther defines a notch 602a4 away from aperture 602a2. Notch 602a4 is configured such that clearance is provided from adjacent structures (e.g., an adjacent conductive pin 104’) during an ultrasonic welding process. As illustrated, notch 602a4 is configured such that tip portion 602a does not interfere with an end portion 104b’ of adjacent conductive pin 104’ during an ultrasonic welding process.

In the illustrated embodiment, notch 602a4 is defined at an edge 602a5 of working surface 602a1. In the illustrated embodiment, notch 602a4 may be described as a rectangular notch (e.g., as viewed from a cross-sectional view of sonotrode 600) and/or as an annular notch surrounding aperture 602a2. In the illustrated embodiment, notch 602a4 may be described as being defined at an intersection of working surface 602a1 and a side surface 602a6 of tip portion 602a.

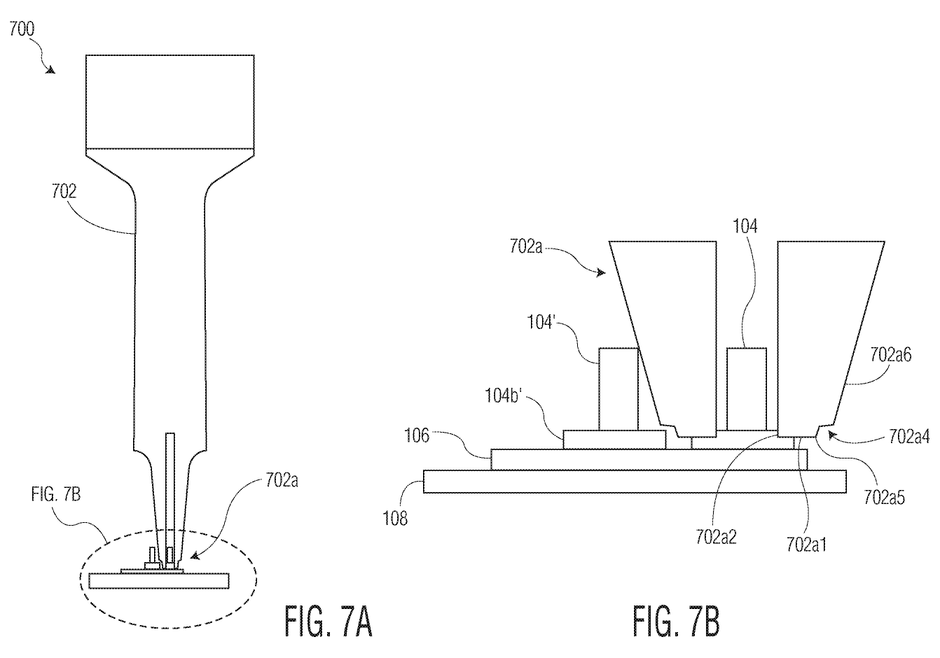

Referring now to FIGS. 7A-7B, a sonotrode 700 configured for use in an ultrasonic welding system (e.g., ultrasonic welding system 900 of FIG. 9) is illustrated. Sonotrode 700 may be used in connection with an ultrasonic welding operation, where a conductive pin (e.g., conductive pin 104) is being welded to workpiece 106 (e.g., a substrate, a semiconductor element, a power module, etc.) supported by support structure 108 (e.g., of an ultrasonic welding system).

Sonotrode 700 is illustrated including a body portion 702 terminating at a tip portion 702a. Tip portion 702a includes a working surface 702a1. Working surface 702a1 defines an aperture 702a2 configured to engage a conductive pin 104 during an ultrasonic welding process. Tip portion 702afurther defines a notch 702a4 away from aperture 702a2. Notch 702a4 is configured such that clearance is provided from adjacent structures (e.g., an adjacent conductive pin 104’) during an ultrasonic welding process. As illustrated, notch 702a4 is configured such that tip portion 702a does not interfere with an end portion 104b’ of adjacent conductive pin 104’ during an ultrasonic welding process.

In the illustrated embodiment, notch 702a4 is defined at an edge 702a5 of working surface 702a1. In the illustrated embodiment, notch 702a4 may be described as a tapered notch (e.g., as viewed from a cross-sectional view of sonotrode 700) and/or as an annular notch surrounding aperture 702a2. In the illustrated embodiment, notch 702a4 may be described as being defined at an intersection of working surface 702a1 and a side surface 702a6 of tip portion 702a.

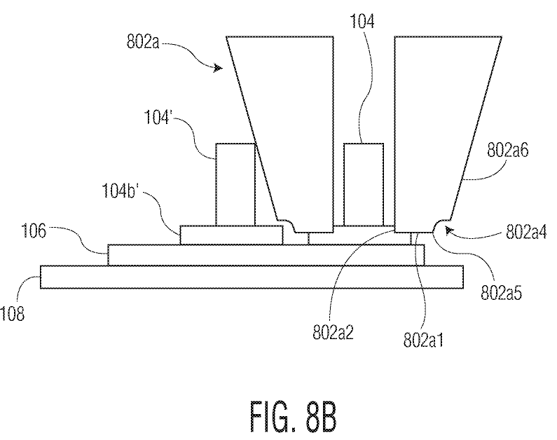

Referring now to FIGS. 8A-8B, a sonotrode 800 configured for use in an ultrasonic welding system (e.g., ultrasonic welding system 900 of FIG. 9) is illustrated. Sonotrode 800 may be used in connection with an ultrasonic welding operation, where a conductive pin (e.g., conductive pin 104) is being welded to workpiece 106 (e.g., a substrate, a semiconductor element, a power module, etc.) supported by support structure 108 (e.g., of an ultrasonic welding system).

Sonotrode 800 is illustrated including a body portion 802 terminating at a tip portion 802a. Tip portion 802a includes a working surface 802a1. Working surface 802a1 defines an aperture 802a2 configured to engage a conductive pin 104 during an ultrasonic welding process. Tip portion 802afurther defines a notch 802a4 away from aperture 802a2. Notch 802a4 is configured such that clearance is provided from adjacent structures (e.g., an adjacent conductive pin 104’) during an ultrasonic welding process. As illustrated, notch 802a4 is configured such that tip portion 802a does not interfere with an end portion 104b’ of adjacent conductive pin 104’ during an ultrasonic welding process.

In the illustrated embodiment, notch 802a4 is defined at an edge 802a5 of working surface 802a1. In the illustrated embodiment, notch 802a4 may be described as a rounded notch (e.g., as viewed from a cross-sectional view of sonotrode 800) and/or as an annular notch surrounding aperture 802a2. In the illustrated embodiment, notch 802a4 may be described as being defined at an intersection of working surface 802a1 and a side surface 802a6 of tip portion 802a.

Certain recesses (e.g., recesses 102a3, 202a3, 302a3, 402a3, and notches 502a4) defined by a sonotrode and described herein are configured to receive a free end (e.g., a tip, a point, etc.) of a conductive pin. Certain notches (e.g., notch 602a4, notch 702a4, notch 802a4, etc.) defined by a sonotrode and described herein are configured to provide clearance from a base portion (e.g., a tip, a point, etc.) of a conductive pin. However, it should be understood that the concepts may be combined in a single sonotrode where (i) recesses are provided to receive a free end of conductive pin(s) and (ii) a notch is provided to provide clearance from a base portion of a conductive pin(s).

Referring now to FIG. 9, an ultrasonic welding system 900 (e.g., a matrix pin welding system) is illustrated. Ultrasonic welding system 900 includes support structure 108 configured for supporting workpiece(s) 106. Ultrasonic welding system 900 is illustrated including an input workpiece supply 106a (e.g., a carrier such as a magazine handler for carrying a plurality of workpieces) configured to carry and/or supply one or more workpieces 106, an output workpiece supply 106b for receiving one or more workpieces 106, and a material handling system 910 configured to move workpieces 106 between input workpiece supply 106a and output workpiece supply 106b.

Ultrasonic welding system 900 can include a vacuum 912 (including vacuum piping 912a) to hold a conductive pin 104 in the aperture (defined by sonotrode 100, 200 . . ., 800) in connection from a conductive pin supply (not illustrated). It should be understood that alternative conductive pin handling configurations (e.g., using a gripping mechanism, a magnetic handling mechanism, etc.) are contemplated within the scope of the invention. In certain applications, a camera 914 (e.g., a vision system) can be used to position portions of ultrasonic welding system 900 in connection with a pick-up or placement operation of conductive pin 104. In certain applications, camera 914 can be used to determine a pattern of a plurality of conductive pins.

Ultrasonic welding system 900 includes a weld head assembly 916 configured to move along the x-axis, y-axis, z-axis, and/or a theta axis (Ø-axis) of ultrasonic welding system 900. It should be understood that not all of these motion axes are required in each application. Weld head assembly 916 includes an ultrasonic converter 918 configured to carry a sonotrode. More specifically, ultrasonic welding system 900 utilizes a sonotrode including a body portion terminating at a working surface of a tip portion, where the working surface defines an aperture configured to engage a conductive pin during an ultrasonic welding process.

The sonotrode included in ultrasonic welding system 900 may be any sonotrode within the scope of the invention, including but not limited to sonotrode 100, sonotrode 200, sonotrode 300, sonotrode 400, sonotrode 500, sonotrode 600, sonotrode 700, sonotrode 800, and/or any other sonotrode configured for use in ultrasonic welding system 900.

It should be understood that a control system 920 can be programmed to implement a welding operation in connection with a given sonotrode used in a particular welding operation. For example, a specific USG, amplitude, frequency, and/or motion profile can be used for a particular sonotrode. Control system 920 may include a computer configured to implement the welding operation with an inventive sonotrode using the specific variables as recited above.

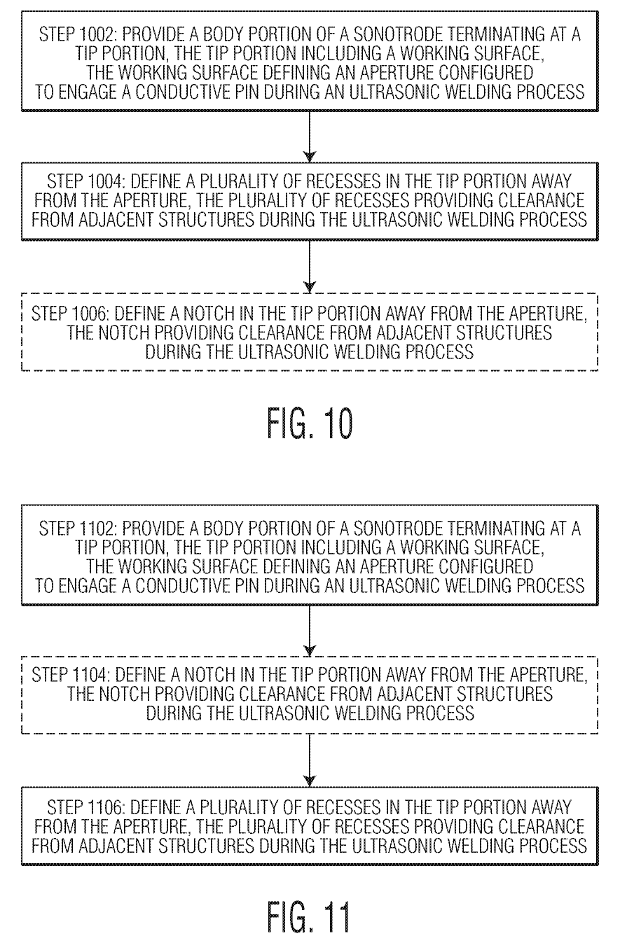

FIGS. 10 and 11 are flow diagrams illustrating methods of preparing a sonotrode for use in connection with an ultrasonic welding process are provided. As is understood by those skilled in the art, certain steps included in the flow diagram may be omitted, certain additional steps may be added, and the order of the steps may be altered from the order illustrated—all within the scope of the invention. Control of aspects of the methods described below may be implemented by one or more computers. Such a computer(s) may be configured to perform any method step recited herein.

Referring specifically to FIG. 10, at Step 1002, a body portion of a sonotrode terminating at a tip portion is provided, the tip portion including a working surface, the working surface defining an aperture configured to engage a conductive pin during an ultrasonic welding process. At Step 1004, a plurality of recesses are defined in the tip portion away from the aperture, the plurality of recesses providing clearance from adjacent structures during the ultrasonic welding process. The plurality of recesses in Step 1004 may be formed in a sonotrode using, for example, drilling, machining, laser machining, electro-discharge machining, or other known techniques in the art. Step 1004 may include arranging the plurality of recesses around the aperture as seen from an end view of the sonotrode (e.g., wherein the plurality of recesses are arranged radially, symmetrically, in a pattern being configured to match a corresponding arrangement of conductive pins adjacent the conductive pin on a workpiece, in a linear configuration, etc.). At optional Step 1006, a notch is defined in the tip portion away from the aperture, the notch providing clearance from adjacent structures during the ultrasonic welding process.

It should be understood that prior to Step 1004, information about a pattern of conductive pins may be determined or provided. For example, information about dimensions (e.g., length, width, diameter, and/or height) of each of a plurality of conductive pins may be determined (e.g., using a vision system, camera 914, a computer, etc.) or provided (e.g., using past process data, using manufacturing drawings, using CAD data, etc.). Further, information about the positional relationship of one conductive pin with respect to one or more of other conductive pins (e.g., the distance between center points or center lines of adjacent conductive pins) may be determined or provided. Such information can be used to determine a pattern of conductive pins to be used in connection with the plurality of recesses of a sonotrode. After determining such a pattern or arrangement, Step 1004 may include arranging the plurality of recesses in a pattern with respect to the aperture as seen from an end view of the sonotrode in order to match a corresponding arrangement of conductive pins (e.g., the arrangement when the conductive pins are bonded to a workpiece using an ultrasonic welding process). In certain embodiments, Step 1004 may include defining ones of the plurality of recesses to receive ones of previously bonded conductive pins during the ultrasonic welding process. In certain embodiments, the body portion includes a cylindrical portion extending to a conical portion, the conical portion including the working surface; in such embodiments, Step 1004 may include defining the plurality of recesses at an intersection between the cylindrical portion and the conical portion. In certain of such embodiments, the intersection includes a curved portion between the cylindrical portion and the conical portion. One or more computers may be configured to control formation of the notches described herein, for example, using any of the information recited above.

Referring now to FIG. 11, at Step 1102, a body portion of a sonotrode terminating at a tip portion is provided, the tip portion including a working surface, the working surface defining an aperture configured to engage a conductive pin during an ultrasonic welding process At Step 1104, a notch is defined in the tip portion away from the aperture, the notch providing clearance from adjacent structures during an ultrasonic welding process. The notch may be formed in the sonotrode using, for example, drilling, machining, laser machining, electro-discharge machining, or other known techniques in the art. Step 1104 may include defining the notch in accordance with any one or more of the following: at an edge of the working surface, as a rectangular notch, as a tapered notch, as a curved notch, at an intersection of the working surface and a side surface of the tip portion, and as an annular notch surrounding the aperture. At optional Step 1106, a plurality of recesses is defined in the tip portion away from the aperture, the plurality of recesses providing clearance from adjacent structures during the ultrasonic welding process.

It should be understood that prior to Step 1104, information about a pattern of conductive pins may be determined or provided. For example, information about dimensions (e.g., length, width, diameter, and/or height) of each of a plurality of conductive pins may be determined (e.g., using a vision system, camera 914, a computer, etc.) or provided (e.g., using past process data, using manufacturing drawings, using CAD data, etc.). Further, information about the positional relationship of one conductive pin with respect to one or more of other conductive pins (e.g., the distance between center points or center lines of adjacent conductive pins) may be determined or provided. Such information can be used to determine a pattern of conductive pins to be used in connection with the notch of a sonotrode. After determining such a pattern or arrangement, Step 1104 may include defining the notch around (e.g., radially, symmetrically with respect to, etc.) the aperture as seen from an end view of the sonotrode in order to match a corresponding arrangement of conductive pins (e.g., the arrangement when the conductive pins are bonded to a workpiece using an ultrasonic welding process). One or more computers may be configured to control formation of the notches described herein, for example, using any of the information recited above.

Various sonotrodes within the scope of the invention (including many of those described herein) include a body portion terminating at a tip portion. The body portion and the tip portion may be formed from a unitary piece of material (e.g., steel, stainless steel, a metal alloy, etc.). Alternatively, the body portion and the tip portion may be separate pieces coupled together (e.g., through brazing or other techniques). In connection with embodiments where the body portion and the tip portion are separate pieces, examples of the material of the body portion include: steel; stainless steel; a metal alloy; etc., and examples of materials of the tip portion include: ceramic; steel; carbide materials; and/or a metal alloy.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A sonotrode configured for use in an ultrasonic welding system, the sonotrode comprising:
a body portion terminating at a tip portion, the tip portion including a working surface, the working surface defining an aperture configured to engage a conductive pin during an ultrasonic welding process,
the tip portion further defining a plurality of recesses away from the aperture, the plurality of recesses providing clearance from adjacent structures during the ultrasonic welding process.

2. The sonotrode of claim 1 wherein the plurality of recesses are arranged around the aperture as seen from an end view of the sonotrode.

3. The sonotrode of claim 1 wherein the plurality of recesses are arranged radially around the aperture as seen from an end view of the sonotrode.

4. The sonotrode of claim 1 wherein the plurality of recesses are arranged symmetrically with respect to the aperture.

5. The sonotrode of claim 1 wherein the plurality of recesses are arranged in a pattern, the pattern being configured to match a corresponding arrangement of conductive pins adjacent the conductive pin on a workpiece during the ultrasonic welding process.

6. The sonotrode of claim 1 wherein the plurality of recesses are arranged in a linear configuration with respect to the aperture.

7. The sonotrode of claim 1 wherein the body portion includes a cylindrical portion extending to a conical portion, the conical portion including the working surface, the plurality of recesses being defined at an intersection between the cylindrical portion and the conical portion.

8. The sonotrode of claim 7 wherein the intersection includes a curved portion between the cylindrical portion and the conical portion.

9. The sonotrode of claim 1 wherein adjacent structures include previously bonded conductive pins.

10. The sonotrode of claim 9 wherein ones of the plurality of recesses are configured to receive ones of previously bonded conductive pins during the ultrasonic welding process.

11. The sonotrode of claim 1 wherein the tip portion further defines a notch away from the aperture, the notch providing clearance from adjacent structures during the ultrasonic welding process.

12. An ultrasonic welding system comprising:
a support structure configured for supporting a workpiece; and
a weld head assembly including an ultrasonic converter and a sonotrode configured for use in the ultrasonic welding system,
the sonotrode including a body portion terminating at a tip portion, the tip portion including a working surface, the working surface defining an aperture configured to engage a conductive pin during an ultrasonic welding process, the tip portion further defining a plurality of recesses away from the aperture, the plurality of recesses providing clearance from adjacent structures during the ultrasonic welding process.

13. A sonotrode configured for use in an ultrasonic welding system, the sonotrode comprising:
a body portion terminating at a tip portion, the tip portion including a working surface, the working surface defining an aperture configured to engage a conductive pin during an ultrasonic welding process,
the tip portion further defining a notch away from the aperture, the notch providing clearance from adjacent structures during the ultrasonic welding process.

14. The sonotrode of claim 13 wherein the notch is defined at an edge of the working surface.

15. The sonotrode of claim 13 wherein the notch is a rectangular notch.

16. The sonotrode of claim 13 wherein the notch is a tapered notch.

17. The sonotrode of claim 13 wherein the notch is a rounded notch.

18. The sonotrode of claim 13 wherein the notch is defined at an intersection of the working surface and a side surface of the tip portion.

19. The sonotrode of claim 13 wherein the notch is an annular notch surrounding the aperture.

20. The sonotrode of claim 13 wherein the tip portion defines a plurality of recesses away from the aperture, the plurality of recesses providing clearance from adjacent structures during the ultrasonic welding process.

21. An ultrasonic welding system comprising:
a support structure configured for supporting a workpiece; and
a weld head assembly including an ultrasonic converter and a sonotrode configured for use in the ultrasonic welding system,
the sonotrode including a body portion terminating at a tip portion, the tip portion including a working surface, the working surface defining an aperture configured to engage a conductive pin during an ultrasonic welding process, the tip portion further defining a notch away from the aperture, the notch providing clearance from adjacent structures during the ultrasonic welding process.

22. The ultrasonic welding system of claim 21 wherein the notch is defined at an edge of the working surface.

23. The ultrasonic welding system of claim 21 wherein the notch is a rounded notch.

24. The ultrasonic welding system of claim 21 wherein the notch is an annular notch surrounding the aperture.

25. A method of preparing a sonotrode for use in connection with an ultrasonic welding process, the method comprising the steps of:
(a) providing a body portion of the sonotrode terminating at a tip portion, the tip portion including a working surface, the working surface defining an aperture configured to engage a conductive pin during the ultrasonic welding process; and
(b) defining a plurality of recesses in the tip portion away from the aperture, the plurality of recesses providing clearance from adjacent structures during the ultrasonic welding process.

26. The method of claim 25 wherein step (b) includes arranging the plurality of recesses around the aperture as seen from an end view of the sonotrode.

27. The method of claim 25 wherein step (b) includes arranging the plurality of recesses radially around the aperture as seen from an end view of the sonotrode.

28. The method of claim 25 wherein step (b) includes arranging the plurality of recesses symmetrically with respect to the aperture.

29. The method of claim 25 wherein step (b) includes arranging the plurality of recesses in a pattern, the pattern being configured to match a corresponding arrangement of conductive pins adjacent the conductive pin on a workpiece during the ultrasonic welding process.

30. The method of claim 25 wherein step (b) includes arranging the plurality of recesses in a linear configuration with respect to the aperture.

31. The method of claim 25 wherein the body portion includes a cylindrical portion extending to a conical portion, the conical portion including the working surface, and wherein step (b) includes defining the plurality of recesses at an intersection between the cylindrical portion and the conical portion.

32. The method of claim 31 wherein the intersection includes a curved portion between the cylindrical portion and the conical portion.

33. The method of claim 25 wherein step (b) includes defining ones of the plurality of recesses to receive ones of previously bonded conductive pins during the ultrasonic welding process.

34. The method of claim 25 further comprising defining a notch in the tip portion away from the aperture, the notch providing clearance from adjacent structures during the ultrasonic welding process.

35. A method of preparing a sonotrode for use in connection with an ultrasonic welding process, the method comprising the steps of:
(a) providing a body portion of the sonotrode terminating at a tip portion, the tip portion including a working surface, the working surface defining an aperture configured to engage a conductive pin during the ultrasonic welding process; and
(b) defining a notch in the tip portion away from the aperture, the notch providing clearance from adjacent structures during the ultrasonic welding process.

36. The method of claim 35 wherein step (b) includes defining the notch at an edge of the working surface.

37. The method of claim 35 wherein step (b) includes defining the notch as a rectangular notch.

38. The method of claim 35 wherein step (b) includes defining the notch as a tapered notch.

39. The method of claim 35 wherein step (b) includes defining the notch as a rounded notch.

40. The method of claim 35 wherein step (b) includes defining the notch at an intersection of the working surface and a side surface of the tip portion.

41. The method of claim 35 wherein step (b) includes defining the notch as an annular notch surrounding the aperture.

42. The method of claim 35 further comprising defining a plurality of recesses in the tip portion away from the aperture, the plurality of recesses providing clearance from adjacent structures during the ultrasonic welding process.
